(19) United States
(12) Patent Application Publication
(10) Pub. No.: US 2004/0003169 A1
(43) Pub. Date: Jan. 1, 2004

(54) Method for executing look up table function

(76) Inventors: Josh Meit, Sunnyvale, CA (US); Lior Friedman, Modi'in (IL)

Correspondence Address: DEKEL PATENT LTD., DAVID KLEIN, BEIT HAROF'IM, 18 MENUHA VENAHALA STREET, ROOM 27, REHOVOT, 76209, IL

(21) Appl. No.: 10/180,513

(22) Filed: Jun. 27, 2002

(51) Int. Cl. G06F 12/00

(52) U.S. Cl. 711/108

(57) ABSTRACT

A method for executing a look up table function, comprising dividing input data of an associative processor array (APA) into at least two fields, each field comprising a smaller amount of bits than the input data, and performing associative array operations on the fields and outputting values from a look up table in response to results of the operations.

### FIELD OF THE INVENTION

The present invention relates generally to associative processors, and particularly to methods for executing look up table functions with associative processors.

### BACKGROUND OF THE INVENTION

An associative processor is a device for parallel processing of a large volume of data. FIG. 1 is a simplified illustration of an art associative processor 10. Associative processor 10 may comprise an associative processor array (APA) 12 of content addressable memory (CAM) cells 14 arranged in rows 16 and columns 18. Associative processor 10 may also include three registers for controlling CAM cells 14: a tag register 20 that includes many tag register cells 22, a mask register 24 that includes many mask register cells 26, and a pattern register 28 that includes many pattern register cells 30. A cell of the array 12, tag register 20, mask register 24 or pattern register 28 may store one bit (0 or 1). Tag register 20 may be a part of a tag logic block (not shown) that communicates with each row 16 via a dedicated word enable line and a dedicated match result line (both not shown), with each tag register cell 22 being associated with one row 16 via a particular word enable line, match result line and a dedicated logic circuit (not shown). Each mask register cell 26 and each pattern register cell 30 may be associated with one column 18.

Each CAM cell 14 may perform two kinds of elementary operations, as directed by the contents of the corresponding cells 22, 26 or 30 of registers 20, 24 and 28: compare operations and write operations. For both kinds of elementary operations, columns 18 that are to be active are designated by the presence of ‘1’ bits in the associated mask register cells 26. The contents of tag register cells 22 may be broadcast to the associated rows 16 as “write enable” signals by the tag logic block via word enable lines, with rows 16 that receive a ‘1’ bit being activated. In a single cycle of compare operations, each activated row 16 may generate a ‘1’-bit match signal on the match result line of that row 16. Each activated CAM cell 14 of that row 16 may compare its contents with the contents of the cell 30 of pattern register 28 that is associated with the column 18 of that CAM cell 14. If the two contents are identical (both ‘0’ bits or both ‘1’ bits), that CAM cell 14 allows the match signal to pass. Otherwise, that CAM cell 14 blocks the match signal. As a result, if the contents of all the activated CAM cells 14 of a row 16 match the contents of corresponding cells 30 of pattern register 28, the match signal reaches the tag logic block and the associated logic circuit writes a ‘1’ bit to the associated tag register cell 22. Otherwise, the associated logic block writes a ‘0’ bit to the associated tag register cell 22. In a single cycle of write operations, the contents of pattern register cells 30 associated with activated columns 18 are written to the activated CAM cells 14 of those columns 18.

In summary, in both kinds of elementary operations, tag register 20 and mask register 24 may provide activation signals and pattern register 28 may provide reference bits. Then, in a compare operation cycle, array 12 may provide input that is compared with the reference bits of pattern register 28, and tag register 20 may receive output (‘1’ for a match, ‘0’ for no match). In a write operation cycle, array 12 may receive write data that is identical to one or more reference bits.

### SUMMARY OF THE INVENTION

The present invention seeks to provide improved methods for executing look up table functions with associative processors, as is described in detail hereinbelow.

There is thus provided in accordance with an embodiment of the present invention a method for executing a look up table function, comprising dividing input data of an associative processor array (APA) into at least two input fields, each input field comprising a smaller amount of bits than the input data, and performing associative array operations on the input fields and outputting values from a look up table in response to results of the operations.

In accordance with an embodiment of the present invention, the input may be divided into a first field comprising a significant bit of the input data and at least one second field comprising the remaining bits of the input data, and the performing may comprise comparing the value of the significant bit to a first binary value, and storing a result of the comparing in a first tag register, and comparing the remaining bits of the input data with corresponding bits of a pattern, and storing results of this comparing in a second tag register.

Further in accordance with an embodiment of the present invention, the method may include outputting values from the look up table in accordance with the results stored in the first and second tag registers.

Still further in accordance with an embodiment of the present invention, if the first binary value is stored in both the tag registers corresponding to a row in the APA, then a first output value may be output from the look up table to a result field in the row, and if the first binary value is stored in one of the tag registers and a second binary value, different from the first binary value, is stored in the other of the tag registers corresponding to the row in the APA, then a second output value may be output from the look up table to a result field in the row.

In accordance with an embodiment of the present invention, the input data may be divided into a subset of the input data and at least one second field comprising the remaining bits of the input data, and a plurality of result fields may be allocated in the APA wherein each result field corresponds to a particular bit combination in the subset of the input data.

Further in accordance with an embodiment of the present invention, bits of the at least one second field may be compared with corresponding bits of a pattern, and results of this comparing may be stored in a tag register, and all possible output values may be written from the look up table into the result fields.

Still further in accordance with an embodiment of the present invention, bits of the subset of the input data may be compared with corresponding bits of the pattern, and results of this comparing may be stored in the tag register, and the results stored in the tag register may be used to determine which of the result fields comprises a desired output value.

In accordance with an embodiment of the present invention, desired output values may be written to one single result field.

Further in accordance with an embodiment of the present invention, the method may comprise dividing the at least one second field into a first sub-field comprising a significant bit of the input data and at least one second sub-field comprising the remaining bits of the at least one second field, and the value of the significant bit may be compared to a first binary value, and a result of the comparing may be stored in a first tag register, and the remaining bits of the at least one second field may be compared with corresponding bits of a pattern, and the results of this comparing may be stored in a second tag register.

Still further in accordance with an embodiment of the present invention, further comprising outputting values from the look up table in accordance with the results stored in the first and second tag registers.

Additionally in accordance with an embodiment of the present invention, if the first binary value is stored in both the tag registers corresponding to a row in the APA, then a first output value may be output from the look up table to at least one of the result fields, and if the first binary value is stored in one of the tag registers and a second binary value, different from the first binary value, is stored in the other of the tag registers corresponding to the row in the APA, then a second output value may be output from the look up table to at least one of the result fields.

In accordance with an embodiment of the present invention, the method further includes allocating a plurality of result fields in the APA wherein each result field corresponds to a particular bit combination in the input data, clearing the result field by writing all zeros thereto, searching for an input value in one of the input fields and for a value of all zeros in the result field, and writing an output value to the result field and the searched-for input value to the one of the input fields.

Further in accordance with an embodiment of the present invention the significant bit of the input data comprises the least significant bit, and comparing the remaining bits of the input data comprises comparing the remaining bits for values v (wherein v=0, 1, 2, . . . k), and the method further comprises outputting values from the look up table by writing the look up table output for input=2v, comprising a logical operation of the second tag register ANDNOT the first tag register, to at least one result field, and writing the look-up table output for input=(2v+1), comprising a logical operation of the first tag register AND the second tag register, to at least one result field.

### BRIEF DESCRIPTION OF THE DRAWINGS

The present invention will be understood and appreciated more fully from the following detailed description taken in conjunction with the appended drawings in which:

FIGS. 1-3 are simplified illustrations of a method for executing a look up function with an associative processor, in accordance with an embodiment of the present invention; and

FIGS. 4-5 are simplified illustrations of a method for executing a look up function with an associative processor, in accordance with another embodiment of the present invention.

### DETAILED DESCRIPTION OF A PREFERRED EMBODIMENT

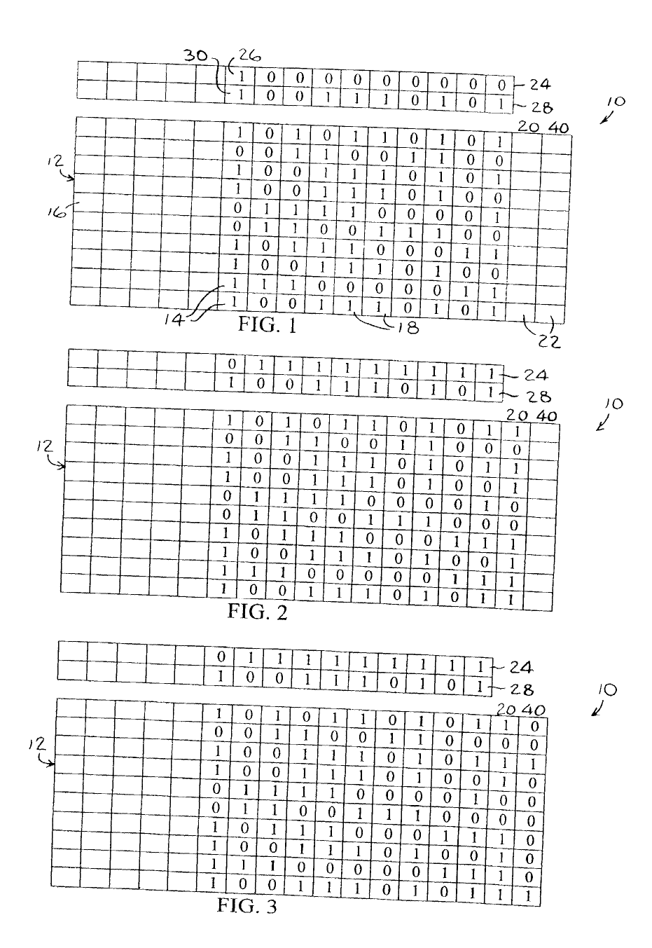

Reference is now made to FIGS. 1-3, which illustrate a method for executing a look up function with associative processor 10, in accordance with an embodiment of the present invention. In FIG. 1, the associative processor 10 may comprise a second tag register 40. (Tag register 20 will accordingly be referred to as the first tag register 20.) In the following illustrative example, the input data of the associative processor 10 comprises 10 bits, but it is appreciated that the invention is not limited to this amount. Pattern register 28 may comprise a pattern to be found in the array 12, such as but not limited to, the illustrated pattern 1001110101. Mask register 24 may or may not restrict the search to certain columns.

The method may commence by comparing the value of one of the bits of the input data, e.g., the MSB (most significant bit), to some binary value, such as ‘1’. This may be carried out by loading 1000000000 in the mask register 24 (the pattern in pattern register 28 may remain as above). The result may be stored in the first tag register 20, as shown in FIG. 2. The pattern stored in pattern register 28 may then be searched for in the remaining bits of each input (in the illustrated example, the remaining 9 bits), with mask register 24 being loaded with 0111111111. The results may be stored in the second tag register 40, as shown in FIG. 3. The method may then identify two patterns for use in a look up table from the results stored in the two tag registers 20 and 40. If both tag registers 20 and 40 indicate a word (‘1’ in both registers), then the corresponding row 16 contains the exact pattern stored in pattern register 28, including the correct MSB of that pattern. If tag register 20 has a ‘0’ stored therein and tag register 40 has a ‘1’ stored therein, then the corresponding row 16 contains the pattern stored in pattern register 28, except for the MSB of that row which is different from the pattern stored in pattern register 28. Accordingly, two entries in the look up table may be found in one cycle, after the MSB has been copied to the first tag register 20. For each entry found, the look up table function may be performed and the corresponding result may be stored in a portion of the array 12, called the output field or result field 50.

The conventional method of executing a look up table function would be to search for each entry and modify the results with the corresponding look up table output. This would take 2ⁿ compare cycles and 2ⁿ write cycles, where n=the number of bits in the look up table input value. In the above example, n=10, meaning there would be 1024×2=2048 cycles. According to the above-described embodiment, the method may reduce the number of compare cycles to (2ⁿ⁻¹) compare cycles, because only one compare is required for every two operations of writing the output from the look up table to the array 12. In the above example, the method would only require 512 compares+1024 writes+1 compare of the MSB to first tag register 20=1537 cycles.

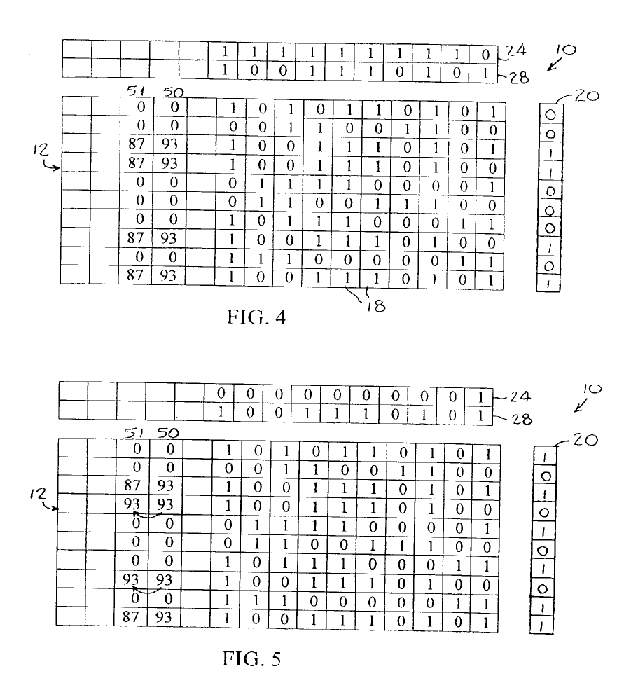

Reference is now made to FIG. 4, which illustrates a method for executing a look up function, in accordance with another embodiment of the present invention. As before, merely for illustrative purposes, the input data of the associative processor 10 may comprise, without limitation, 10 bits. Pattern register 28 may comprise a pattern to be found in the array 12, such as but not limited to, the illustrated pattern 1001110101. This embodiment may employ just one tag register, such as tag register 20.

A plurality of result fields 50 (vectors comprising a certain number of columns) may be allocated in array 12, wherein each result field 50 corresponds to a particular bit combination in a subset of the input bits. For example, as shown in FIG. 4, two result fields 50 and 51 may be allocated in available columns 18 of array 12, respectively corresponding to the LSB (least significant bit) values 0 and 1.

The pattern stored in pattern register 28 may then be searched for in the remaining bits of each input (in the illustrated example, the remaining 9 bits), with mask register 24 being loaded with 1111111110. For a row 16 that matches the pattern for these 9 bits, a ‘1’ may be stored in the corresponding tag register 20. The look up table function may then be performed for the tag cells that have ‘1’ stored therein. Since the look up table function is carried out with the LSB value unknown, there will be two possible outputs. For example, the output of the look up table function for the LSB value=0 may be stored in result field 50. The output of the look up table function for the LSB value=1 may be stored in result field 51. It is noted that the associative processor 10 may write both vectors concurrently, thereby reducing the complexity of the look up table.

The pattern in the LSB column of the pattern stored in pattern register 28 may then be searched for in the LSB bit of each input in array 12 (in the illustrated example, the bit in the first column), with mask register 24 loaded with 0000000001. For a row 16 that matches the pattern for this bit, a binary value, e.g., ‘1’, may be stored in the corresponding tag register 20, as shown in FIG. 5. In the illustrated example, the LSB value of the correct pattern is 1. This means that the output value stored currently in result field 51 for those rows whose tag register value is ‘1’ is correct (i.e., the desired value), whereas the output value stored currently in result field 51 for those rows whose tag register value is ‘0’ is not correct. The method of this embodiment of the invention may then proceed to write the correct output values to one single result field. In other words, after all the values have been searched, the result fields may be merged into a single result field (column) by identifying which of the result fields contains the correct result based on the LSB of each input. For example, result field 51 may be chosen as the single result field in which to write the correct output values. The correct output values may be written to result field 51 in accordance with the results stored in tag register 20.

In general, the n-bit input may be divided into two fields of lengths m and n−m, respectively. According to the embodiment of FIG. 4, the first round of operations may comprise (2^{n-m}) compare cycles+(2^{n-m}) write cycles for the output of the look up table. This may be followed by (2^{m}) compare cycles+(2^{m}) write cycles for the remaining m bits. This may be further followed by (2^{m-1}) compare cycles+(2^{m-1}) write cycles in order to merge the results to one result field. In the above example, n=10 and m=2. Accordingly, in this example, the method would only require 2⁸+2⁸+2²+2²+2¹+2¹=524 cycles.

In summary, in the embodiment of FIGS. 4-5, two possible results may be written to two or more fields at once. Writing to two or more fields may be accomplished by loading the mask register of the two or more fields and loading pattern register bits of the two or more fields with respective output values. A write operation in a single cycle may write respective values to the two or more fields. After all possibilities have been written to the two or more fields, the untested bit may be used to determine which values in one of the output fields should be moved to another, single output field.

The method described hereinabove with reference to FIGS. 1-3 may be combined with the method described with reference to FIGS. 4-5. This would further reduce the complexity of the basic look up table, as is now explained. Two bit slices may be selected as unknown, e.g., the least significant bit (bit 0) and the second least significant bit (bit 1). The value of the second LSB may be loaded to the first tag register 20, by comparing that bit alone to ‘1’. This may be accomplished, as described hereinabove, by selecting that bit only in the mask register 24 and enabling all rows in array 12 to participate in the operation.

Next, the remaining bits (bits 2-9) may be selected and the corresponding pattern 10011101 of pattern register 28 may be searched for in array 12. The results of the search may be stored in the second tag register 40. Using both tag registers 20 and 40, two output fields may now be written in a single cycle to result fields 50 and 51. The values of the two result fields are the two possible outputs that the combination of the searched-for value of in bits 2-9 plus a value of ‘1’ in bit ‘1’ could have, since the value in bit ‘0’ is still unknown. The write operation may be carried out in an associative processor by generating a word-enable signal for each row in array 12 comprising executing a logical AND operation between corresponding bits in first and second tag registers 20 and 40 (meaning that the bits in first and second tag registers 20 and 40 must both be ‘1’).

A second write operation may follow the first write operation, wherein using both tag registers 20 and 40, two output fields may be written in a single cycle to result fields 50 and 51. The values of these result fields are the two possible outputs that the combination of the searched-for value of in bits 2-9 plus a value of ‘0’ in bit ‘1’ could have. This write operation may be carried out by generating a word-enable signal for each row in array 12 by executing a logical operation between corresponding bits in tag registers 20 and 40, whereby the bit in second tag register 40 must have ‘1’ and the bit in first tag register 20 must have ‘0’ (second tag register 40 ANDNOT first tag register 20).

Afterwards, the input field (bits 2-9 only) may again be selected, and a new input value may be loaded for this input field. The array may be compared for the new input value and the results may be stored in second tag register 40. Once again, two output values may be written to result fields 50 and 51 in a single cycle (second tag register 40 AND first tag register 20), and two other output values may be written to result fields 50 and 51 in another single cycle (second tag register 40 ANDNOT first tag register 20).

The above procedure may be repeated for all possible values in bits 2-9. It is noted that the value in first tag register 20 may remain unchanged once it has been loaded at the first iteration with bit 1.

Once this has been completed, result fields 50 and 51 may be merged into one. This may be accomplished in the following manner:

(a) The second unknown bit column in the input field (in the described example, bit 0) may be selected. The pattern register may be loaded with a value ‘1’ at that field and all words may be searched. The result may be stored in first tag register 20.

(b) All bits in the first result field 50 may be searched and a value of all 0's may be loaded to the corresponding pattern register bits. A write operation may be executed by using first tag register 20 to generate the word-enable signal (so that only words indicated by first tag register 20 will write “0000000000” to the first output field).

(c) For each bit in second result field 51 (referred to as bit i), bit i may be selected and the value ‘1’ may be searched for. The results may be stored in second tag register 40. Bit i may be selected in the first result field 50, and the value ‘1’ may be written to that bit slice in all words indicated by first tag register 20 AND second tag register 40, i.e., using logical AND between respective bits in first tag register 20 and second tag register 40 to generate the word-enable signal for each row.

Alternatively step (c) may be replaced with the following: for each bit in the second result field 51, bit i may be selected and the LSB in the input field may also be selected. The value ‘1’ may be searched for in both bit columns. The results of the search may be stored in the first tag register 20. The value ‘1’ may now be written to bit i in the first result field 50, using first tag register 20 to generate the word-enable signal.

In accordance with another embodiment of the invention, further improvements may be achieved in reducing the amount of operations to perform look up table functions. For example, an instruction set of the associative processor, which may comprise instructions for performing the elementary operations of the processor, may divide the mask and pattern registers into a plurality of sectors, e.g., sectors of 16 bits. In a single compare cycle, a 16-bit value may be loaded to one sector in the mask or pattern register, and the remaining sectors in the mask or pattern may either be cleared or remain unchanged.

In the first embodiment of FIGS. 1-3, there is only one result field 50. An example is now considered wherein the output is 16 bits (a full sector). If a compare operation were to be performed on nine bits of the input field, followed by a write operation on 16 bits of the result field, the following five operational cycles would be performed:

1. Load the mask register of the input field

2. Load the pattern register of the input field

3. Load the mask register of the result field

4. Load the pattern register of the result field for writing the first output from the look up table to the array 12

5. Load the pattern register of the result field for writing the second output from the look up table to the array 12

The amount of operational cycles may be reduced by first clearing the result field, that is, by writing all zeros thereto. The compare and write operations for writing the results from the look up table may then comprise the following:

1. Load the mask register for both the input field and the result field.

2. For the look up table, load the input field sector of the pattern register with an input value and clear all other sectors and do the compare (only one cycle). Note that this step searches for the input value and also for 0000000000000000 in the output field. The search for all the zeros does not affect the search for the input value because the result field was cleared before starting the search.

3. Load the output field sector of the pattern register leaving the other sectors unchanged, and write the 16-bit value to the result field and also the searched-for input value to the input field. Note that the input field remains unchanged, since the input value is already in input words indicated by the tag register.

In this way, every compare takes only one cycle and every write takes only one cycle. There are only two additional setup cycles for loading the mask register.

In accordance with yet another embodiment of the invention, the amount of operations may be reduced by using the LSB as the unknown bit and proceeding sequentially through the look-up table. For example, the method may commence by searching for 0 in bits 1-9. The look up table values may correspond to either input=0 (if the LSB=0) or input=1 (if the LSB=1). Accordingly, the look-up table output for input=0 (second tag register 40 ANDNOT first tag register 20) may be written to its corresponding result field, and the look-up table output for input=1 (first tag register 20 AND second tag register 40) may be written to its corresponding result field. The procedure may continue by searching for 1 in bits 1-9. The look up table values may correspond to either input=binary 10=decimal 2 (if the LSB=0), or input=binary 11=decimal 3 (if the LSB=1). The outputs for input=decimal 2 and input=decimal 3 may accordingly be written in their respective result fields. The search may then continue for 2 in bits 1-9, and the output for input=4 (binary 100) and input=5 (binary 101) may accordingly be written in their respective result fields. In general, the method may comprise searching for values v (wherein v=0, 1, 2, . . . k) in bits 1 through n (n=9 in the above example). The look up table output for input=2v (second tag register 40 ANDNOT first tag register 20) may be written to its corresponding result field, and the look-up table output for input=(2v+1) (first tag register 20 AND second tag register 40) may be written to its corresponding result field.

It will be appreciated by person skilled in the art, that the present invention is not limited by what has been particularly shown and described herein above. Rather the scope of the present invention is defined only by the claims that follow:

What is claimed is:

1. A method for executing a look up table function, comprising:
dividing input data of an associative processor array (APA) into at least two input fields, each input field comprising a smaller amount of bits than said input data; and
performing associative array operations on said input fields and outputting values from a look up table in response to results of said operations.

2. The method according to claim 1, wherein said dividing comprises dividing said input into a first field comprising a significant bit of said input data and at least one second field comprising the remaining bits of said input data, and said performing comprises:
comparing the value of said significant bit to a first binary value, and storing a result of said comparing in a first tag register; and
comparing the remaining bits of said input data with corresponding bits of a pattern, and storing results of this comparing in a second tag register.

3. The method according to claim 2, further comprising outputting values from said look up table in accordance with the results stored in said first and second tag registers.

4. The method according to claim 2, wherein if said first binary value is stored in both said tag registers corresponding to a row in said APA, then outputting comprises outputting a first output value from said look up table to a result field in said row, and if said first binary value is stored in one of said tag registers and a second binary value, different from said first binary value, is stored in the other of said tag registers corresponding to said row in said APA, then outputting comprises outputting a second output value from said look up table to a result field in said row.

5. The method according to claim 1, wherein said dividing comprises dividing said input data into a subset of said input data and at least one second field comprising the remaining bits of said input data, and allocating a plurality of result fields in said APA wherein each result field corresponds to a particular bit combination in said subset of said input data.

6. The method according to claim 5, wherein said performing comprises:
comparing bits of said at least one second field with corresponding bits of a pattern, and storing results of this comparing in a tag register; and
writing all possible output values from said look up table into said result fields.

7. The method according to claim 6, wherein said performing further comprises:
comparing bits of said subset of said input data with corresponding bits of said pattern, and storing results of this comparing in said tag register; and
using the results stored in said tag register to determine which of said result fields comprises a desired output value.

8. The method according to claim 7, further comprising writing desired output values to one single result field.

9. The method according to claim 5, further comprising dividing said at least one second field into a first sub-field comprising a significant bit of said input data and at least one second sub-field comprising the remaining bits of said at least one second field, and said performing comprises:
comparing the value of said significant bit to a first binary value, and storing a result of said comparing in a first tag register; and
comparing the remaining bits of said at least one second field with corresponding bits of a pattern, and storing results of this comparing in a second tag register.

10. The method according to claim 9, further comprising outputting values from said look up table in accordance with the results stored in said first and second tag registers.

11. The method according to claim 9, wherein if said first binary value is stored in both said tag registers corresponding to a row in said APA, then outputting comprises outputting a first output value from said look up table to at least one of said result fields, and if said first binary value is stored in one of said tag registers and a second binary value, different from said first binary value, is stored in the other of said tag registers corresponding to said row in said APA, then outputting comprises outputting a second output value from said look up table to at least one of said result fields.

12. The method according to claim 11, further comprising:
comparing bits of said subset of said input data with corresponding bits of said pattern, and storing results of this comparing in one of said tag registers; and
using the results stored in said one of said tag registers to determine which of said result fields comprises a desired output value.

13. The method according to claim 12, further comprising writing desired output values to one single result field.

14. The method according to claim 1, further comprising:
allocating a plurality of result fields in said APA wherein each result field corresponds to a particular bit combination in said input data;
clearing said result field by writing all zeros thereto;
searching for an input value in one of said input fields and for a value of all zeros in said result field; and
writing an output value to said result field and the searched-for input value to said one of said input fields.

15. The method according to claim 2, wherein said significant bit of said input data comprises the least significant bit, and wherein comparing the remaining bits of said input data comprises comparing the remaining bits for values v (wherein v=0, 1, 2, . . . k), and further comprising outputting values from said look up table by writing the look up table output for input=2v, comprising a logical operation of said second tag register ANDNOT said first tag register, to at least one result field, and writing the look-up table output for input=(2v+1), comprising a logical operation of said first tag register 20 AND said second tag register, to at least one result field.
